(19) United States
(12) Patent Application Publication
(10) Pub. No.: US 2005/0096961 A1
(43) Pub. Date: May 5, 2005

(54) METHOD AND SYSTEM TO DETERMINE A NEED TO HIRE A NEW EMPLOYEE TO WORK WITHIN A MANUFACTURING SYSTEM

(75) Inventors: Dwayne Vander Schaaf, Windsor, Ontario (CA); Terry Huhtala, Windsor, Ontario (CA); Beth Peacock, Ann Arbor, MI (US); Ron Gray, Rosemount, MN (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 10/605,829

(22) Filed: Oct. 29, 2003

(51) Int. Cl. G06F 17/60

(52) U.S. Cl. 705/9

(57) ABSTRACT

A computer-implemented method and system for determining a need to hire a new employee. The need to hire a new employee is determined and based on a labor resource planning agent (LRPA) which automatically calculates human resource deficiencies and excesses for use by a human resource manager in making hiring decisions.

### BACKGROUND OF INVENTION

1. Field of the Invention

The present invention relates to the allocation of resources within manufacturing systems. In particular, the present invention provides a method and system to determine a need to hire a new employee to work in the manufacturing system.

2. Background Art

In a manufacturing system, multiple plants manufacture different products for use in assembling a final product. The automotive industry is an example of one such manufacturing system which relates to the manufacturing of vehicles.

Vehicles include a number of individual components that are assembled in a final assembly plant to produce the completed vehicle. Typically, the manufacturer produces many, if not all, of the components by constructing a number of plants and hiring a number of employees to work in the plants.

In the past, hiring of new employees was controlled at the plant level. Meaning, each plant was responsible to determine its human resource requirements and to hire enough employees to meet the human resource requirements.

The plants have a tendency to hire excessive numbers of employees to insure enough employees are on staff and available to meet a production schedule. This is a problem because the excessive employees add unnecessary costs to the manufacturing system. As such, there exists a need for a method and system which can be used to determine a legitimate need to hire new employee such that the unnecessary hiring of excessive employees is limited.

### SUMMARY OF INVENTION

The present invention meets the need identified above to limit the hiring of excessive and unnecessary employees with a method and system for monitoring and controlling human resource allocation within a multiple plant manufacturing system.

One aspect of the present invention relates to a computer-implemented method to determine a need to hire a new employee. The method is for use in a multiple plant manufacturing system where each plant is assigned a human resource allocation based on an anticipated production schedule.

The method requires each plant to forecast its human resources requirements each month with respect to the anticipated production schedule. A central network computer receives the forecasts from each plant, preferably through an electronic transfer of information, and compares the forecast against the allocation.

Through the comparison, the computer calculates human resource excesses and human resource deficiencies for each plant based on differences between the human resource allocation assigned to each plant and the forecasted human resource requirements submitted by the plants.

In this manner, human resource excesses correspond with a plant forecasting a need for less employees in a particular month than the number of employees allocated for that month. Similarly, human resource deficiencies correspond with a plant forecasting a need for more employees in a particular month than the number of employees allocated for that month.

The human resource deficiencies, thus, indicate the plant is requesting additional employees to meet the production schedule. The reasons why the plant believes additional employees are necessary can vary. In some cases, the reasoning may be accurate, such as if there has been a shift in production schedule or some other increase in work volume, however in some cases, the reasoning may be inaccurate, such as if the plant is over assessing absenteeism.

It is preferable to limit the hiring of unnecessary new employees. Thus, the method includes a verification process where the computer calculates various indicators which can be used to determine whether the plant's request for new employees is required.

It is also preferable to limit the hiring of necessary employees if other employees can be allocated from other plants in the manufacturing system to cover the human resource deficiency. Thus, the method includes a reallocation process which details the human resource capabilities of other plants in the system to determine whether employee can be allocated from another to cover the human resource deficiency.

It is also preferable to limit the hiring of necessary employees, even if employees cannot be allocated from other plants, if the production schedule can be changed without disrupting the manufacturing system. Thus, the method includes a scheduling process which can be used to determine whether the production schedule can be changed to ameliorate the human resource deficiency.

One aspect of the present invention relates to a system to execute the method identified above. The system includes central network computer and a labor resource planning template (LRPT). The LRPT include a number of predefined fields which each plant fills in to forecast their monthly human resource requirements, i.e., needs, for the month.

Preferably, the LRPT is a computer spreadsheet or other electronic medium which can be electronically, typically from a human resource manager or other high level supervisor, transferred to the computer. The computer also receives human resource allocations for each plant. The computer can calculate human resource excesses and deficiencies based on differences between the allocated requested human resources.

To facilitate the analysis of the differences, i.e., the human resource excesses and deficiencies, the computer outputs the labor resource planning agent (LRPA). The LRPA is preferably an electronic pivot table or other computer-readable and manipulatable file. The LRPA outputs each calculation performed by the computer so that a human resource manager can make determine whether there is a legitimate need to hire new employee. Preferably, the calculations made by the computer permit the human resource manager to make informed decision so that the unnecessary hiring of excessive employees can be limited.

### BRIEF DESCRIPTION OF DRAWINGS

FIG. 1 illustrates a computer-implemented system for determining a need to hire a new employee in a multiple manufacturing plant system, in accordance with the present invention;

FIG. 2 illustrates a labor resource planning template for use by each plant in the multiple plant manufacturing system to forecast a human resource requirement, in accordance with the present invention;

FIG. 3 illustrates a labor resource planning agent which is automatically generated by a computer for use by a human resource manager in making hiring decisions, in accordance with the present invention; and

FIG. 4 illustrates an exemplary flowchart for describing a method for determining a need to hire a new employee, in accordance with the present invention.

### DETAILED DESCRIPTION

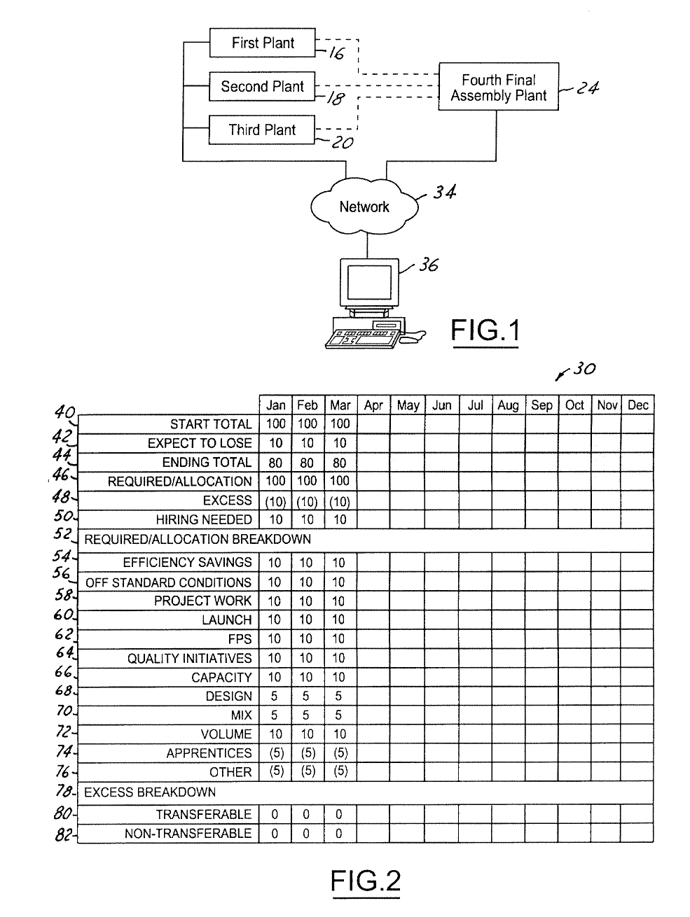

FIG. 1 illustrates a system 10 for monitoring and controlling human resource allocation within a multiple plant manufacturing system 12 to limit the hiring of excessive and unnecessary employees.

This system generally relates to an automotive manufacturing process, but the present invention is not so limited. Rather, the present invention, as one having ordinary skill in the art will appreciate, is applicable to many other types of manufacturing systems.

The system 10 shown in FIG. 1 includes a first plant 16, a second plant 18, a third plant 20, and a fourth plant 24. Each plant manufactures a product for use in producing a vehicle. As shown in FIG. 1, the first 16, second 18, and third 10 plants provide products for final assembly at the fourth plant 24. The fourth plant 24, commonly known as a final assembly plant, assembles the products from the first 16, second 18, and third 20 plants to produce the final vehicle.

Each plant is assigned a production schedule that sets a time frame for the production of its product. Because the fourth plant receives parts from each of the first 16, second 18, and third 20 plants, the production scheduling to produce a completed vehicle for the fourth plant 24 is dependent on the other plants. As such, for the fourth plant 24 to meet a predefined schedule, the other plants must meet their respective schedules.

Generally, automotive manufacturing cycles stretch across multiple years such that there is some overlap between each year. The overlap tends to produce a constant supply of products and continued operation of the plants most of the time.

The continued operation of each plants are not without variations in productivity. Throughout the year, the human resources needed to meet the production schedule varies as the production schedule demands vary.

In some months, the production schedule may be light and less employees would be needed, but in other months, the production schedule may be heavier and more employees would be needed. In addition, changes to the manufacturing process, such as a break through process improvement or failure of equipment, can either increase or decrease the need for additional human resources. The possibilities are too variable to detail, as one of ordinary skill in the art will appreciate.

It is the responsibility of each plant to monitor its production schedule and to insure the plant has enough employees to meet the production schedule demands. Because the number of employees hired at each plant effects the cost to the entire manufacturing system 10, it is desirable to require that each plant submit a forecast of its human resource needs.

FIG. 2 illustrates an exemplary labor resource planning template (LRPT) 30 which each plant fills in to facilitate reporting and tracking the human resource requirements of each plant.

Generally, the LRPT 30 is a computer-readable spreadsheet file or other electronic medium. The LRPT includes a number of predefined fields that breakdown the human resource requirements for each plant. The LRPT stretches across multiple months so that each plant can forecast their human resource requirements for each month.

As shown in FIG. 1, the file can uploading from each plant to a network computer 36. The computer 36 can then perform computations and comparisons with the other plant. Preferably, each plant in the manufacturing system LRPTs submitted by each fills in the LRPT and uploads it to the network computer on a monthly basis.

The LRPT 10 includes a number of predefined fields which force the plants to detail their human resources. The fields shown in FIG. 2, however, are not intended to limit the scope or application of the present invention. In fact, other fields could also be used, as understood by one having ordinary skill in the art.

A field 40 relates to a start total of employees. This field is a forecast of the employees the plant expects to have on staff at the beginning of the month. Generally, this number is carried over from the preceding month, but it can also change from month to month if hiring approvals are made or denied.

A field 42 relates to an expected loss of employees. The losses can be for any number reasons, including temporary absenteeism, death, retirement, and others. Optionally, more detail on the expected losses could be provided to further define the expected losses.

A field 44 relates to an ending total of employees. The ending total can be inputted or automatically calculated by the computer.

A field 46 relates to the required number of employees to run the plant. This number is updated monthly by each plant to so that improvements and changes in the number of required employees can be noted. The allocation portion is described in more detail below. It relates the number of employees allocated for that time period at the beginning of the manufacturing cycle or the number of employees approved for allocation at some point during the manufacturing cycle.

A field 48 relates to the excess employees. The excess employees are determined if the plant is forecasting a need for less employees. Generally, the excess employee values equals the difference between the end total and the required/allocation total. However, the excess value can also be effected, as described below in more detail, by the type employees need. The plant may have excess employees in one type of work area even though the plant is needs to hire more employees in another area because some employees cannot work in other work areas. This situation can lead to excess employees even though the ending total of employees is less than the required/allocation of employees.

A field 50 relates to a hiring need. The hiring need is the summation of the plant's need to hire a new employee. Like the excess field, the hiring need field generally relates to the difference between the ending total and the required/allocation total. However, the hiring need can also include hiring request for certain work areas even if other work areas have excess employees.

A section 52 provides a breakdown for the required number of employees needed to operate the plant. The fields in this section are used, as described below in more detail, by a human resource manager in analyzing the human resource needs of the plant. The total number of employees in this section equals the required number of employees noted in field. As such, the manner in which the plant internally allocates resources can be determined for analysis.

A field 54 relates to efficiency savings. The efficiency savings relate to predetermined forecasts of changes in the manufacturing process. The efficiency changes can be positive and negative, a positive change would be improvement to the manufacturing process which decreases the number of needed employees and a negative change could be a problem in the manufacturing process which increased the number of need employees, such as an increase in the production schedule due to known demand increases.

A field 56 relates to off standard changes in the manufacturing process. These changes are unforeseen variations due to non-standard manufacturing deficiencies which are temporarily corrected by hiring extra employees to control quality.

A field 58 relates to project work. This field covers the forecasted number of employees to cover planned projects for the given period. This field can include positive and negative decreases in the needed number of employees, as planned.

A field 60 relates to increases in the number of employees due to a planned launch period. The launch period generally relates a situation when a new product is introduced and increase numbers of employees are need to insure the introduction goes smoothly. Typically, this is a transient increase which should be offset with a launch decrease at a later point in time. These changes should be consistent with the approved launch plan. A permanent increase should be classified in a different field.

A field 62 relates to employees dedicated to production support. This field can include the number of employees needed to lead groups of production line employees, or other similar support positions.

A field 64 relates to employees dedicated to quality initiatives. The quality initiatives generally relate to new program initiated after the start of the manufacturing process to change the quality process. The change can increase or decrease the number of needed employees.

A field 66 relates to capacity changes in employees due to changes in operating conditions. Such as increase demand due to unforeseen sales or a decrease in demand due to unforeseen lack of sales. Typically, this field relates to production line speed.

A field 68 relates to design changes to the product being manufactured. The design changes can require increases or decreases in the number of employees needed to implement the new design.

A field 70 relates to mix which is similar to a design change, but different in that it relates to a change driven by customer demand. Generally, this field is more applicable to plants which produce various versions of the same product, for example a plant which produces the same vehicle with an option for a convertible or hard-top.

A field 72 relates to volume. The volume field is similar to the capacity field, but more focused needing more employees to meet the same capacity, as opposed to an increase of capacity.

A field 74 relates to apprentices. The apprentices field covers contractual & operational apprenticeship requirements which must be met throughout the year, depending on a labor contract.

A field 76 relates to other. The other field covers actual/Forecasted working required changes that cannot be classified in the above categories.

A field 78 relates to an excess breakdown. The excess breakdown indicates the number of transferable and non-transferable excess employees at the plant. This field is helpful, as described below in more detail, to facilitate transferring excess employees to other plants to cover deficiencies at those plants.

A field 80 relates to transferable employees. Transferable employees are those employees which can be mandatorily transferred to other plants within a given geographical zone. Typically this zone extends to 50 miles from their original plant.

A field 82 relates to non-transferable employees. Non-transferable employees are those employees which are excess employees but cannot be mandatorily transferred to other plants. The non-transferable employees are still tracked so that offers or requests can be made to them for transfer.

The LRPT 30 details the human resource requirements for each plant as determined by the plants themselves. This is commonly referred to plant level data where the plants determine the human resources they believe to be required in order to meet the desired productions schedule. The plants, however, have a tendency to hire excessive numbers of employees to insure enough employees are on staff and available to meet a production schedule. This is a problem because the excessive employees add unnecessary costs to the manufacturing system.

As described above, each of the fields receive values for the respective plant. Throughout the manufacturing year, the plant transfers the LRPT 30 to the computer 36 for processing and comparison on a monthly basis. Preferably, each plant fills in values for at least the next three months so that a forecast of 90 days is provided. The values beyond 90 days can optionally filled in or required to be filled in depending on the need to compare the human resource requirements to later months.

Because the LRPT 30 is preferably submitted by each plant on a monthly basis, the human resource manager must make hiring decisions on a monthly basis. In other words, each submitted LRPT 30 can potentially indicate a plant desires additional employees. The human resource manager must determine whether the need is accurate and whether it would be advisable to hire the new employee or to allocate an employee from another plant or to change the productions schedule.

In addition to receiving the monthly LRPT forecasts from each plat, the computer includes a human resource allocation for each plant. Preferably, the human resource allocations are in a format similar to the LRPT so that the detail in the LRPT forecasts are included in the allocation.

In one embodiment of the invention, the allocation is simply a LRPT which is filled in for the entire year with the total number of employees allocated for each month. In this manner, the monthly LRPTs can be easily compared to the corresponding month of the allocation.

Generally, the human resource allocation at least includes the highlight portions shown in FIG. 2 filled in with values for each month of the year. When a new employee is hired, the corresponding allocation (shaded region) is updated to reflect the hiring.

The human resource allocation is a separate template filled out for each plant prior to the beginning of the production scheduled. For example, if the production schedule covered the months between January and December, the human resource allocation would be completed in the December prior to the kickoff of the production schedule in the following January.

Generally, the human resource allocation for the plant is determined by a manufacturing operator who oversees the entire manufacturing system. However, the operator receives some inputs from the plants and the productions schedule for the plant when determining the allocation of human resources for the plant if needed.

In this manner, the human resource excesses correspond with a plant forecasting a need for less employees in a particular month than the number of employees allocated for that month, and the human resource deficiencies correspond with a plant forecasting a need for more employees in a particular month than the number of employees allocated for that month.

The human resource deficiencies, thus, indicate the plant is requesting additional employees to meet the production schedule. The reasons why the plant believes additional employees are necessary can vary. In some cases, the reasoning may be accurate, such as if there has been a shift in production schedule or some other increase in work volume, however in some cases, the reasoning may be inaccurate, such as if the plant is over assessing absenteeism.

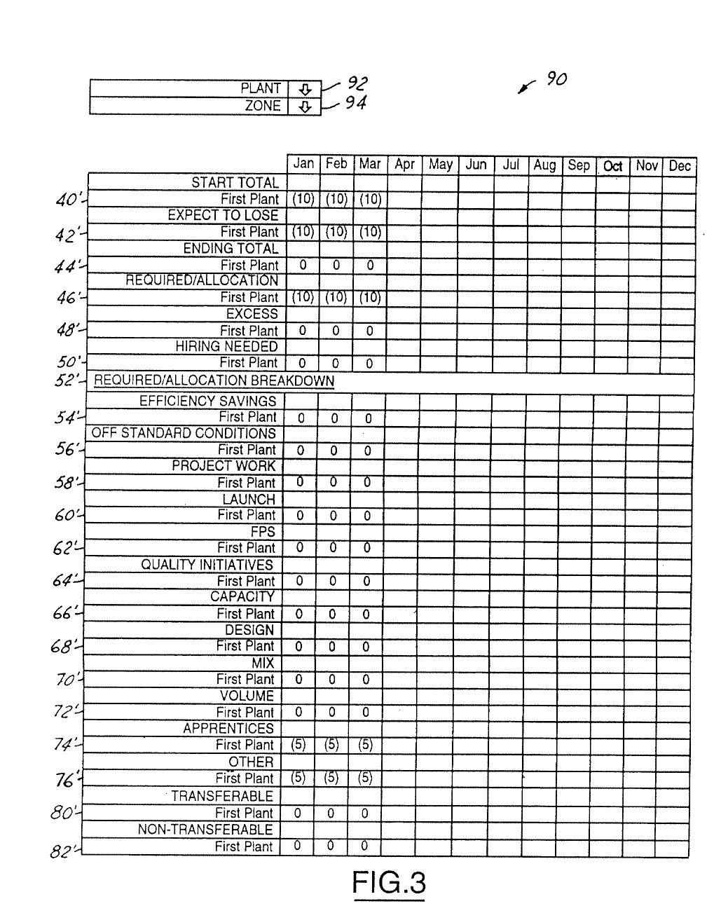

In response to the comparison, the computer outputs a labor resource planning agent (LRPA) 90. FIG. 3 illustrates an exemplary LRPA 90 configured for the LRPT format shown in FIG. 2.

The LRPA 90 is preferably a electronic pivot table or other computer-readable and manipulatable file. The LRPA 90 outputs each calculation performed by the computer so that a human resource manager has sufficient information to determine whether there is a legitimate need to hire a new employee. In this manner, the unnecessary hiring of excessive employees is limited. Preferably, the human resource manager is able to control human resource allocation within a multiple plant manufacturing system to limit the hiring of excessive and unnecessary employees.

FIG. 3 illustrates an exemplary LRPA 90 configured for the LRPT format shown in FIG. 2. The LRPA 90 outputs the computer's calculation of the difference between the allocation and the monthly forecasts in each category. The differences are highlight by parenthesis or lack thereof, negative differences are shown with parenthesized values and positive differences are shown with non-parenthesized values.

The LRPA includes a plant selection button 92 and a zone 94 selection button. The plant selection button 92 is used to pull up an LRPA for a particular plant. As the manufacturing system includes multiple plants, this is a useful tool to find information for a particular plan. Preferably, the plant button 92 provides a drop-down menu listing all the plants in the manufacturing system with an optional selection to view all the plant in the system. The zone button 94 pulls up plants in a common geographic area. As described below in more detail, employees within a common geographic area can be transferred to other plants. In this manner, employees from plants having excess employees can be transferred to plants have insufficient employees. The zone button is also a drop-down menu of zones. Preferably, the zones are selected by geography or by distance from the plant selected with the plant button, as long as the plant button is not used to select all the plants.

FIG. 3 illustrates exemplary data which would appear if the plant button 92 was used to select the first plant without making any selection with the zone button. If the zone button 94 were used in this case to select plants within transferring distance relative to the first plant, then the data for plant three would appear below the data for the first plant, but the data for the second and fourth plant would not, as the third plant is within 50 miles (preferable transfer distance) of the first plants but the second and fourth plants beyond the transfer distance.

As shown in Field 40′ the LRPA 90 indicates that the first plant has 10 more starting employees than previously allocated. In general, negative effects shown in parentheses and positive effects are shown without parentheses. With this negative effect of field 40′ was determined by the computer automatically calculating a difference between the value entered in Field 40, shown in FIG. 2, and the value added in the allocation for field 40. Similar calculations are produced for each field in the LRPA 90. In this manner, the computer outputs human resource deficiencies and excesses for use by the human resource manager in making hiring decisions.

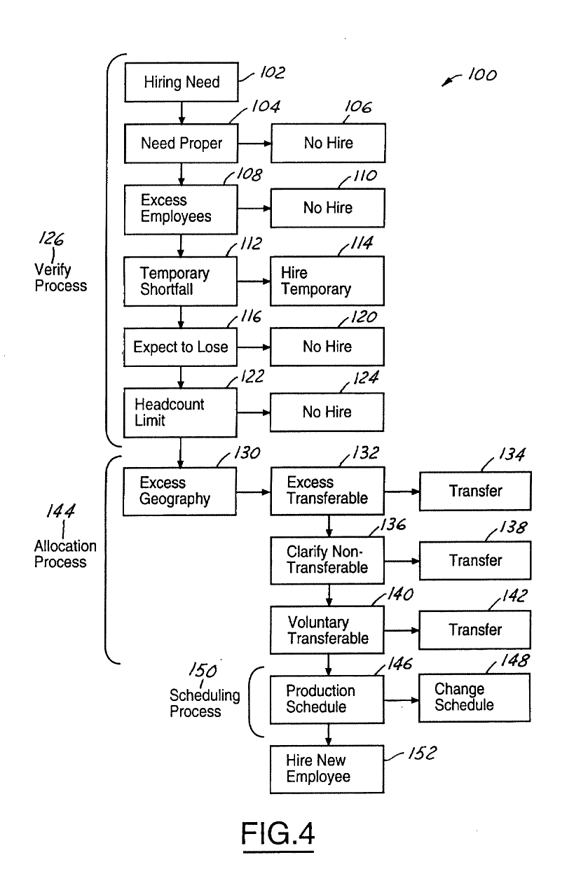

FIG. 4 illustrates an exemplary flowchart 100 which is stored in an electronic medium of the computer 36 for use by a human resource manager to determine a need to hire a new employee. The flowchart 100 is not intended to limit the scope of the present invention. Rather, it provides one example of systematic approach for analyzing and monitoring the hiring requests for each plant which can be executed by a supervisor operating above the plant level. Preferably, the method shown is contained within a interactive program on the computer 36 which the human resource manager can access through a portal or other user interface.

The program would provide question similar to those shown in FIG. 4 which the manager would be required to answer before moving through each block. In this manner, the systematic integrity of the process would be maintained and a record could be kept of the decision making process. Of course, such a program and forcing the manager to answer each question may not be required if the manager is able to navigate the LRPA without such directions, which could be common with experienced managers.

A block 102 relates to determining whether there is a hiring need. The hiring need is determined from the hiring need field if a parenthesized value is shown. The parenthesized value appears if the value in the ending total field is less than the value in the required/allocation field. The computer preferably automatically calculates this value.

A block 104 corresponds to determining whether the hiring need determine in block is proper. This block relates to reviewing the data in fields in the required/allocation breakdown section. Parenthesized values indicate the new resource are being requested beyond what was allocated for the that resource. Non-parenthesized values indicate less resource are being requested relative to the allocation for that resource. (The allocation also can include previous hiring approvals or retractions which are inputted during the year to amend the allocation determined at the beginning of the year.)

Preferably, the human resource manager can interpret the values for each field in the breakdown/allocation section to make the determination as to whether the hiring need is proper. Generally, this determination is driven by the changes in values. The LRPA typically only shows differences between the allocation values and the plant requested values. As such, the human resource manager can review the required/allocation breakdown section and preferably deny hiring if the changes are abnormal.

A block 106 recommend not hiring the new employee if block 104 indicates the change to be improper.

A block 108 determines whether excess employees are available to fill the hiring need. The excess employees are determined upon analysis of the excess employee field and the required/allocation breakdown section. The resource manager reviews these portion of the LRPA to determine if employees can be switched from different work areas in the plant to cover a human resource deficiency in one of the other work areas.

A block 110 recommends not hiring the new employee if block 104 indicates the change to be improper.

A block 112 determines whether the hiring need is based on a temporary shortfall of employees if block 108 determines there a no excess employees to cover the hiring need. The temporary shortfall requires the resource manager to review subsequent months to determine whether the hiring is temporary.

Typically, this can be seen if a parenthesize value appears and the current month and subsequent months include non-parenthesized values. Generally, temporary employees can be hired for less than 90 days without requiring benefits and other additional costs.

A block 114 recommends hiring a temporary employee if the shortfall is temporary.

A block 116 determines whether the plant is overestimating the lose of employees. This determination is made based on the expect to lose field. It is a common problem for plants to inflate the expect to lose field by including additional employees to compensate for no-shows or other absenteeism problems. In some cases, an additional breakdown section can be include in the LRPT and the LRPA to force the plants to breakdown the numbers totaled in the expect to lose field.

A block 120 recommends not hiring the new employee if block 116 indicates the expect to lose numbers are inflated.

A block 122 relates to determining whether the plant is over their headcount limit. The headcount limit relates the number of employees working for the plant at the end of the year. Preferably, the plant begins and ends the year within a predefined headcount range. In some cases, more lenient hiring may be permitted if the plant remains below the headcount total.

A block 124 recommends not hiring the new employee if block 122 indicates that the plant is likely to surpass the headcount total.

The foregoing blocks are referred to as a verification process 126. It is preferable to limit the hiring of unnecessary new employees. Thus, the verification process verifying that various indicators which can be used to determine whether the plant's request for new employees is required are reviewed. The verification indicates the need to hire the employee is probably legitimate. However, the method of the present invention preferably continues to analyze whether other solutions are available which do not require hiring new employees.

A block 130 relates to analyzing whether other employees from other plants in the same geographical area are available. This block requires selection of zone button and picking the transferable button to pull up the plants within a transferable distance relative the first plant, i.e. the third plant. This determination is generally based on reviewing the excess employees of the other plant in the breakdown/allocation section.

A block 132 determines whether excess employees are transferable and a block 134 recommends transferring employees if the excess employees from the other plant can be mandatory transferred. This decision is typically driven by the type of employee needed and the contractual parameters for the employee which indicate whether the employee can be mandatory transferred.

The block 136 also relates to analyzing whether other employees from other plants in non-transferable geographical area are available if block 132 determines no employees can be forced to transfer. This block requires selection of zone button and picking the non-transferable button to pull up the plants within a non-transferable distance relative the first plant (the second and fourth plant) can be allocated to cover the hiring need. This determination is generally based on reviewing the excess employees of the other plant in the breakdown/allocation section.

The block 136 relates to inquiring into why the excess employees of the other plants cannot be transferred if the 132 determine non-transferable employees to be available. Generally, some plant mischaracterize or misclassify their employees to prevent such transfers because it is more desirable, from the plant level, to have as many employees as they can to insure enough are always available. Preferably, the inquire forces the plants to make some employees available for transfer.

A block 138 recommend transferring non-transferable the employees are re-categorized in block 136.

A block 140 relates to canvassing the non-transferable employees to determine if any employees would voluntarily transfer if block 136 fails to locate any transferable employees. This process can include enticing the employees with additional benefits.

A block 142 relates to transferring the non-transferable employees who voluntarily transfer. Block 130-142 relate to an allocation process 144 for allocating employees from other plants to cover a hiring need.

A block 146 relates to determining whether the production schedule of the first plant or another plant can be changed to ameliorate the hiring need. In some cases, simply shifting the production schedule by days can ameliorate the hiring need or shifting the production schedule at another plant so that employees can be transferred therefrom can ameliorate the hiring need.

A block 148 relates to changing the production schedule, and optionally transferring employees based on the schedule change, to cover the hiring need.

The foregoing is referred to as a scheduling process 150. It is preferable to limit the hiring of necessary employees, even if employees cannot be allocated from other plants, if the production schedule can be changed without disrupting the manufacturing system. Thus, the method includes this scheduling process which can be used to determine whether the production schedule can be changed to ameliorate the human resource deficiency.

A block 152 finally relates to hiring a new employee if the allocation and scheduling process cannot cover the hiring need.

As described above, the present invention provides a unique and novel computer-implemented method and system for determining a need to hire new employees. In accordance within the present invention, the hiring of unnecessary and excessive employees can be limited to decrease an overall manufacturing system cost. While the best mode for carrying out the invention has been described in detail, those familiar with the art to which this invention relates will recognize various alternative designs in the embodiments for practicing the invention as defined by the following claims.

While the best mode for carrying out the invention has been described in detail, those familiar with the art to which this invention relates will recognize various alternative designs and embodiments for practicing the invention as defined by the following claims.

1. A computer-implemented method to determine a need to hire a new employee to work within a manufacturing system, the method comprising:
receiving a first plant human resource requirement for a first plant of the manufacturing system and receiving a second plant human resource requirement for a second plant of the manufacturing system;
calculating in a computer a first plant human resource difference for the first plant and a second plant human resource difference for the second plant based on the computer automatically comparing the first and second plant human resource requirements against respective first and second plant predefined human resource allocations; and
determining a need to hire a new employee for the first plant if both (i) the first plant human resource difference indicates a first plant human resource deficiency such that the new employee is needed by the first plant to satisfy the first plant human resource requirement, and (ii) the second plant human resource difference indicates that the second plant cannot allocate second plant human resources from the second plant to the first plant to cover the first plant human resource deficiency.

2. The method of claim 1 wherein determining the need to hire the new employee further comprises comparing a first plant production schedule and the first plant human resource difference to determine that the first plant production schedule cannot be changed to cover the first plant human resource deficiency.

3. The method of claim 2 wherein determining the need to hire the new employee further comprises comparing a second plant production schedule and the second plant human resource difference to learn that the second plant production schedule cannot be changed to allocate second plant human resources to the first plant to cover the first plant human resource deficiency.

4. The method of claim 1 wherein determining the need to hire the new employee further comprising verifying the first plant human resource deficiency to insure only authentic needs to hire a new employee are determined.

5. The method of claim 4 wherein verifying the first plant human resource deficiency comprises receiving the first plant human resource requirement in a first plant labor resource planning report, wherein the first plant labor resource planning report includes a number of predefined fields to be filed in by the first plant for the purpose of providing a breakdown of the first plant human resource requirement according to the predefined fields.

6. The method of claim 5 wherein the first labor resource planning report is a computer-readable spreadsheet and wherein calculating in the computer the first human resource difference for the first plant comprises the computer automatically comparing the first plant predefined human resource allocation and the first labor resource planning report to output a first human resource difference forecast which indicates in each field of the first labor resource planning report the corresponding human resource differences.

7. The method of claim 5 wherein the received human resource requirements include a three month forecast of human resource requirements for the first plant, and wherein verifying the human resource deficiency of the first plant comprises determining the human resource deficiency of the first plant extends beyond 90 days.

8. The method of claim 5 further comprising determining a need to hire a temporary employee if the human resource deficiency of the first plant fails to extend beyond 90 days.

9. A computer system to determine a need to hire a new employee to work within a manufacturing system, the system comprising:
means for receiving a first plant human resource requirement for a first plant of the manufacturing system and receiving a second plant human resource requirement for a second plant of the manufacturing system;
means for calculating a first plant human resource difference for the first plant and a second plant human resource difference for the second plant based on the computer automatically comparing the first and second plant human resource requirements against respective first and second plant predefined human resource allocations; and
means for determining a need to hire a new employee for the first plant if both (i) the first plant human resource difference indicates a first plant human resource deficiency such that the new employee is needed by the first plant to satisfy the first plant human resource requirement, and (ii) the second plant human resource difference indicates that the second plant cannot allocate second plant human resources from the second plant to the first plant to cover the first plant human resource deficiency.

10. The system of claim 9 wherein determining the need to hire the new employee further comprises means for comparing a first plant production schedule and the first plant human resource difference to determine that the first plant production schedule cannot be changed to cover the first plant human resource deficiency.

11. The system of claim 10 wherein determining the need to hire the new employee further comprises means for comparing a second plant production schedule and the second plant human resource difference to learn that the second plant production schedule cannot be changed to allocate second plant human resources to the first plant to cover the first plant human resource deficiency.

12. The system of claim 9 wherein determining the need to hire the new employee further comprising means for verifying the first plant human resource deficiency to insure only authentic needs to hire a new employee are determined.

13. The system of claim 11 wherein verifying the first plant human resource deficiency comprises receiving the first plant human resource requirement in a first plant labor resource planning report, wherein the first plant labor resource planning report includes a number of predefined fields to be filed in by the first plant for the purpose of providing a breakdown of the first plant human resource requirement according to the predefined fields.

14. The system of claim 13 wherein the first labor resource planning report is a computer-readable spreadsheet and wherein calculating the first human resource difference for the first plant comprises a computer automatically comparing the first plant predefined human resource allocation and the first labor resource planning report to output a first human resource difference forecast which indicates in each field of the first labor resource planning report the corresponding human resource differences.

15. The system of claim 14 wherein the received human resource requirements include a three month forecast of human resource requirements for the first plant, and wherein verifying the human resource deficiency of the first plant comprises determining the human resource deficiency of the first plant extends beyond 90 days.

16. The method of claim 15 further comprising determining a need to hire a temporary employee if the human resource deficiency of the first plant fails to extend beyond 90 days.

17. A computer-implemented method to determine a need to hire a new employee to work within a manufacturing system, the method comprising:
receiving a first plant human resource requirement for a first plant of the manufacturing system and receiving a second plant human resource requirement for a second plant of the manufacturing system;
calculating in a computer a first plant human resource difference for the first plant and a second plant human resource difference for the second plant based on the computer automatically comparing the first and second plant human resource requirements against respective first and second plant predefined human resource allocations; and
determining a need to hire a new employee for the first plant if (i) the first plant human resource difference indicates a first plant human resource deficiency such that the new employee is needed by the first plant to satisfy the first plant human resource requirement, (ii) the second plant human resource difference indicates that the second plant cannot allocate second plant human resources from the second plant to the first plant to cover the first plant human resource deficiency, and (iii) a first plant production schedule cannot be changed to cover the first plant human resource deficiency.

18. The method of claim 17 wherein determining the need to hire the new employee further comprising verifying the first plant human resource deficiency to insure only authentic needs to hire a new employee are determined.

19. The method of claim 18 wherein verifying the first plant human resource deficiency comprises receiving the first plant human resource requirement in a first plant labor resource planning report, wherein the first plant labor resource planning report includes a number of predefined fields to be filed in by the first plant for the purpose of providing a breakdown of the first plant human resource requirement according to the predefined fields.

20. The method of claim 19 further comprising verifying extends beyond 90 days and determining a need to hire a temporary employee if the human resource deficiency of the first plant fails to extend beyond 90 days.
